(19) United States
(12) Patent Application Publication
(10) Pub. No.: US 2013/0339487 A1
(43) Pub. Date: Dec. 19, 2013

(54) Method and Apparatus for URL Handling

(71) Applicant: Andy Wu, Lexington, MA (US)

(72) Inventor: Andy Wu, Lexington, MA (US)

(21) Appl. No.: 13/524,198

(22) Filed: Jun. 15, 2012

(51) Int. Cl. G06F 15/16

(52) U.S. Cl. 709/219

(57) ABSTRACT

Methods and apparatus for processing and handling URL are disclosed. A URL-action table is relied on for storing registered applications with corresponding domain names. The registered applications may differ from common web browsers. When a URL or the hypertext referring to a URL is clicked, the domain name included in the URL is extracted and used to search the URL-action table for the registered application. If the registered application is valid, the application is invoked. Otherwise, a default web browser is invoked.

### TECHNICAL FIELD

The present invention relates to processing and handling of URL (Uniform Resource Locator) on a mobile device or in a computer system.

### BACKGROUND

In computing, Universal Resource Locator (URL) generally refers to the standard naming convention universally recognized for referencing a data location on the Internet. Often, the term “URL” (uniform resource locator) is used interchangeably with the term “URI” (uniform resource identifier), which is a specific text string identifying an address referencing an Internet resource.

The Uniform Resource Locator (URL) standard was established in 1994 by Tim Berners-Lee and the URI working group of the Internet Engineering Task Force (IETF) as an outcome of collaboration started at the IETF Living Documents “Birds of a Feather” session in 1992. The URL format combines the pre-existing system of domain names (created in 1985) with file path syntax, in which forward slashes are used to separate folder and file names. The URL often utilizes the existing conventions in which server names can be prepended to complete file paths that are preceded by a double-slash (//).

A URL is generally expressed in the following syntax: a scheme name (commonly referred to as the protocol), followed by a colon, two slashes, then, depending on scheme, a server name (exp, ftp, www, smtp, etc.) followed by a dot (.) then a domain name (alternatively, IP address), a port number, the path of the resource to be fetched or the program to be run, and then for programs such as Common Gateway Interface(CGI)scripts, a query string, and an optional fragment identifier. For example: a URL may take the following syntax:

scheme://domain:port/path?query_string#fragment_id

A URL is normally used in a document or an email to refer to an Internet data resource. The link embedded in the document may be implemented as hypertext and the URL is supplied as hypertext reference attribute. For example:

<αhref=http://www.uspto.gov/dashboards/patents/main.dashxml/> Text </α>

A user may click on the above hypertext to access information stored at the Internet site: www.uspto.gov/dashboards/patents/main.dashxml. Currently, a click action on a hypertext referencing a URL will start a web browser (for example, Microsoft Internet Explorer, Firefox browser, Google Chrome browser or a browser on a mobile phone or tablet) to access the contents on a remote server whose address is defined by the URL. If the URL in the hypertext link is referencing the resource included in an already-opened web browser, a new web browser may or may not be started, depending on the specific implementation. A web browser is a software application for retrieving, presenting, and traversing information resources on the World Wide Web. It can access any available web server identified by a URL and is not specifically designed for remote servers identified by a single domain name.

As smart phones and mobile devices such as tablet computers has become ever more popular, many customized applications are being developed for smart phones and mobile devices to provide access to remote servers and to improve user interface for the specialized display and computing environment of mobile devices. These applications may be preferred by the users over the simple standard web browser interface because they provide more functionalities and richer user experience. These customized software applications are different from a general purpose web browser, because they are designed to connect and access remote servers identified by only one or a few specific domain names. They normally do not have options to connect to other unrelated servers.

However, when a user of a mobile device or a computer system clicks on a URL embedded as hypertext on a webpage, in a document, or in an email, a web browser is always started even though a customized application may be available to access the remote sever.

There is a need for improved methods and apparatus for processing and handling a URL when it is clicked by a user.

### SUMMARY

This summary is provided to introduce a selection of concepts in a simplified form that are further described below in the Detailed Description. This summary is not intended to identify key features of the claimed subject matter, nor is it intended to be used in determining the scope of the claimed subject matter.

Methods and apparatus are described for handling the click action of a URL. In some embodiments, a URL-action table is generated for registering an application with one or more domain names. The URL-action table includes a list of registered applications. The URL-action table may be stored on a mobile device or a remote server. Each registered application is associated with a domain name in the URL-action table. A user may access and modify the URL-action table through a user interface. The user may register a customized application with a specific domain name by adding an entry in the URL-action table. In one embodiment, when a hypertext that references a URL and is embedded in an email or document is clicked, the URL referenced by the hypertext is parsed to retrieve the domain name included in the URL. The claimed invention examines the URL-action table to check whether an application is registered with the domain name and if so, whether the registered application is available on the device. If available, the registered application is invoked. If no application is registered with the domain name, or if the registered application is not available on the device, a default web browser is invoked.

### DESCRIPTION OF THE DRAWINGS

The foregoing aspects and many attendant advantages of this invention will become more readily appreciated through reference to the following detailed description when taken in conjunction with the accompanying drawings.

FIG. 1 is a flow chart illustrating an exemplary embodiment of the present invention.

FIG. 2 illustrates an exemplary table listing one or more domain names and corresponding registered applications.

FIG. 3 is a flow chart illustrating an exemplary user registration process for registering an application with corresponding domain name.

FIG. 4 illustrates a modified table with a newly added application registered with a new domain name.

FIG. 5 illustrates an exemplary apparatus configured to implement the present invention.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

The present invention provides methods and apparatus that enable intelligent handling of a click action on a URL on a mobile device or a computer system. Instead of a default web browser, a click action on a URL may invoke an existing customized application that is registered for the domain name specified in the URL. The invention can be implemented different ways. For example, it can be implemented as a system service running in the background to process URL click events or as an invisible web browser in the place of a standard web browser application to handle URL click events.

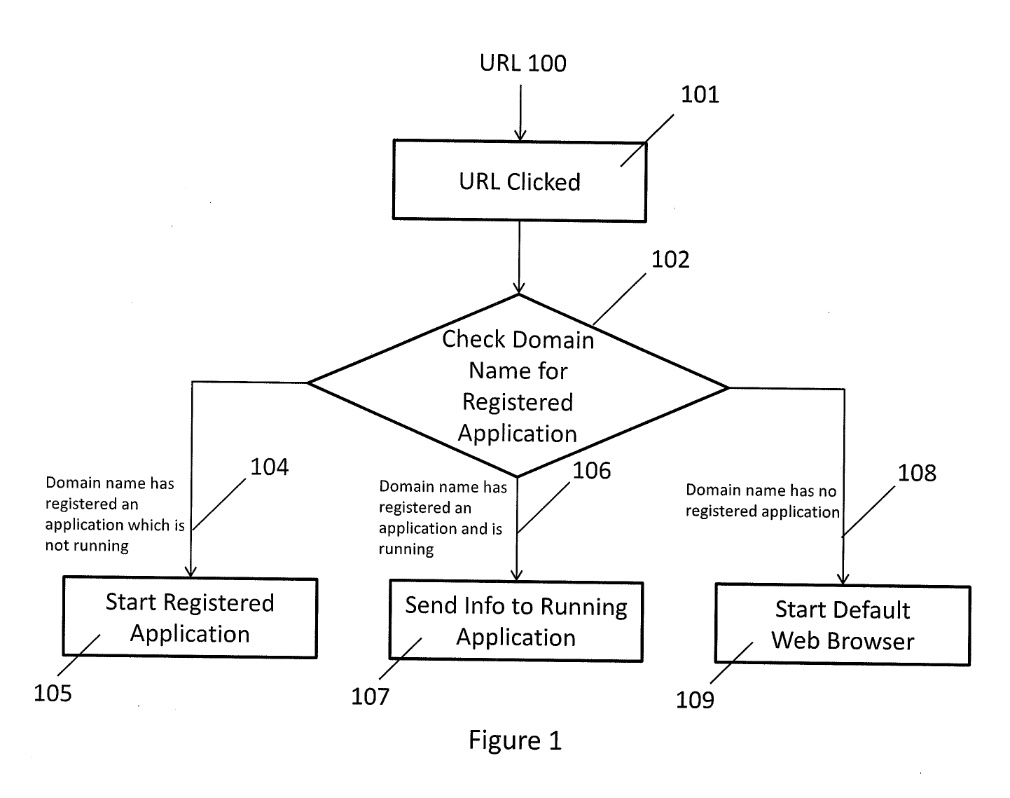

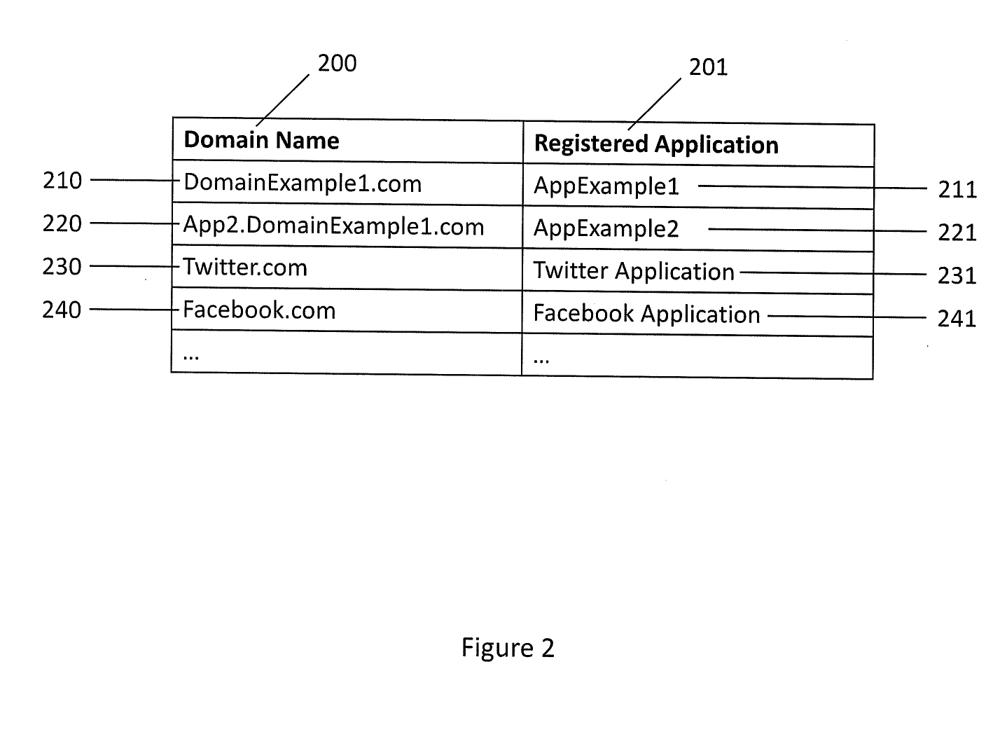

FIG. 1 illustrates the work flow of an exemplary URL handling process on a mobile device. A URL 100 is included in a webpage, email, or document. When the hypertext including the URL 100 is clicked (step 101), the domain name included in the URL is used to search a URL-action table to see if a registered application is available on the device for the domain name (step 102). In some embodiments, the URL-action table may be maintained on the mobile device. In some embodiments, the URL-action table may be maintained on a remote server. The URL-action table includes a list of domain names and their corresponding applications (see FIG. 2). Generally, the applications included in the URL-action table are available on the device for the URL handling process to invoke or execute. In certain scenarios, a registered application that used to be available on the device may become unavailable. In some embodiments, the URL handling process will check the availability of a registered application before invocation or execution.

After locating the domain name in the URL-action table, the URL handling process decides whether there is a registered application or that no registered application is associated with the domain name (step 102).

If there is no registered application associated with the domain name (step 108), a default web browser will be started (step 109).

If there is a registered application associated with the domain name (step 104 and step 106), the URL handling process further decides whether the registered application is running or not. If the registered application is not running (step 104), the URL handling process starts the registered application (step 105). If the registered application is running, the URL handling process sends relevant data to the running application for handling the URL that has been clicked (step 107). The data sent by the registered application may be generic data related to or required by the registered application or data specific to the clicked URL.

In those scenarios in which the registered application is not available on the device, a default web browser application may be started.

FIG. 2 illustrates an exemplary URL-action table. The URL-action table in FIG. 2 includes two columns. The first column, “Domain Name,” contains four domain names, each corresponding to a registered application listed in the second column, “Registered Application.” FIG. 2 shows that application “AppExample1” 211 is registered with domain name “DomainExample1.com” 210. A domain name may also include subdomains. Each subdomain may have a separate application registered with it. Therefore, the main domain name may have multiple applications registered with. For example, in FIG. 2, subdomain “App2.DomainExample1.com” 220 is registered with application “AppExample2” 221. Application “AppExample 1” and application “AppExample 2” are both registered with the same domain name “DomainExample1.com”.

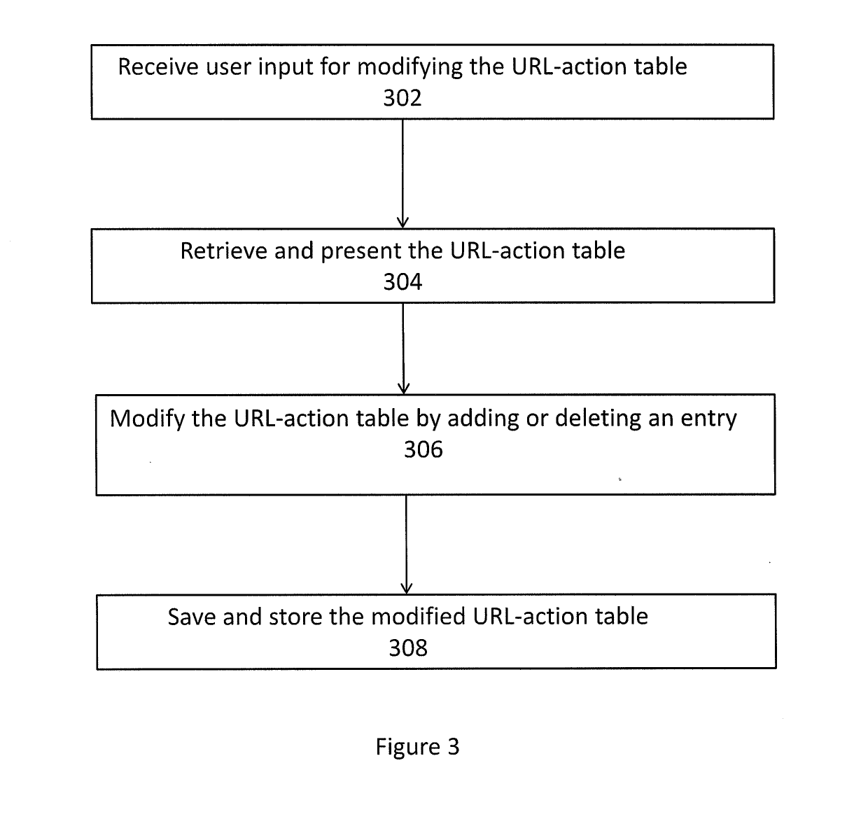

The URL-action table shown in FIG. 2 may be created and initialized by the system software running on the mobile device or the computer system. The URL-action table can be modified by a user to add or remove a registered application. FIG. 3 illustrates an exemplary process for a user to modify the URL-action table.

In FIG. 3, a user input is received through an I/O device on a mobile device or a computer system (step 302). The user input indicates that the user wants to modify the URL-action table. In step 304, the URL-action table is retrieved and displayed on a display device. The user modifies the URL-action by either adding an entry to the table or removing an entry from the table (step 306). The modified URL-action table is saved and stored (step 308).

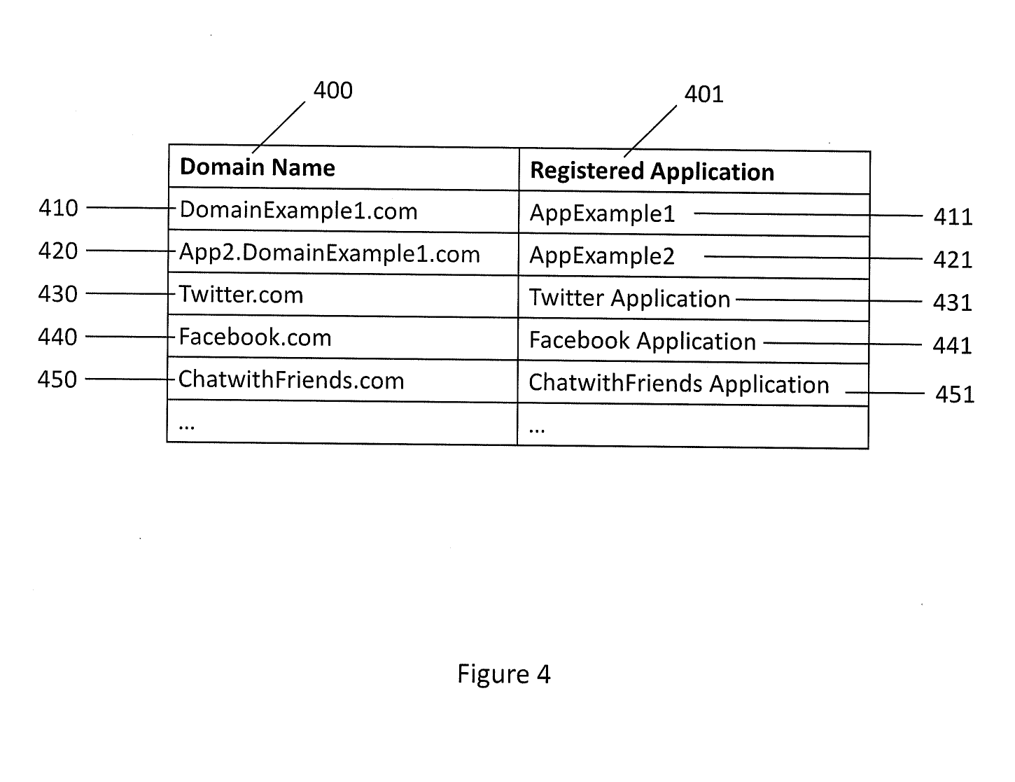

FIG. 4 illustrates a modified URL-action table that includes an added fifth entry:

ChatwithFriends.com ChatwithFriends Application.

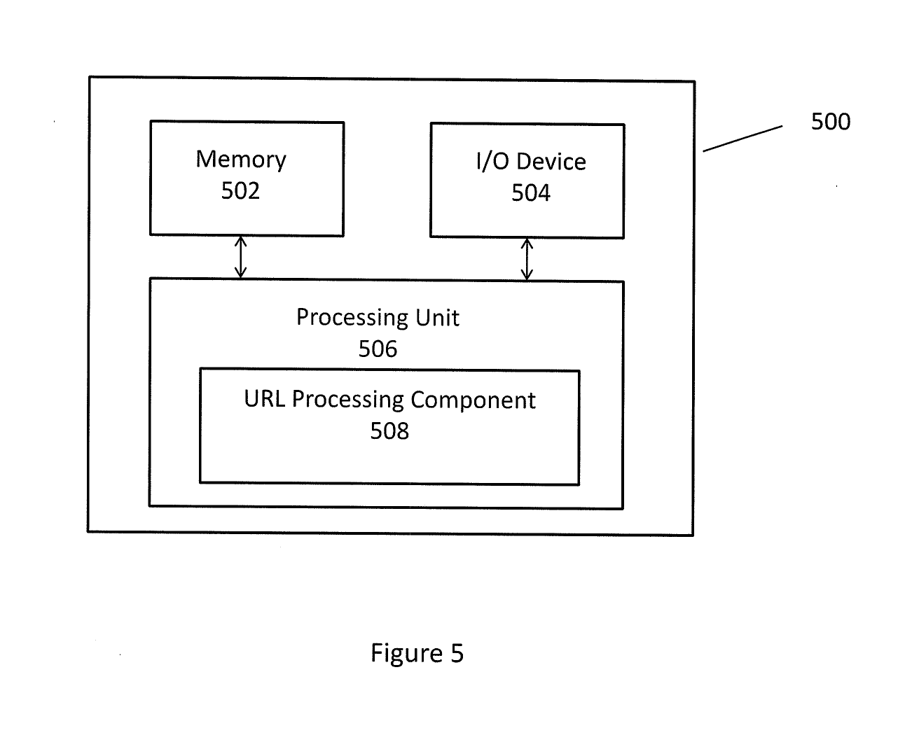

FIG. 5 illustrates an exemplary apparatus 500 suitable for implementing the above described methods. The apparatus 500 includes a memory 502, an I/O device 504, and a processing unit 506. The memory 502 is configured to store data related to URL processing and handling. The I/O device 504 is configured to receive user input, and to output and display computational results. The processing unit 506 is configured to handle the URL processing and handling and any related computations. The processing unit 506 further comprises a URL processing component 508 configured to retrieve an application based on a URL-action table. The URL-action table includes a list of applications registered with corresponding domain names. The URL-action table may be stored in the memory 502 or a remote server. The URL processing component 508 is further configured to determine whether the retrieved application is valid or not. For example, the URL processing component 508 may check if the registered application is available or not. If the retrieved application is determined to be valid, the URL processing component 508 invokes the retrieved application. Otherwise, the URL processing component 508 invokes a default web browser.

Although the present invention has been described in terms of various embodiments, it is not intended that the invention be limited to these embodiments. Modification within the spirit of the invention will be apparent to those skilled in the art. For example, instead of using a system wide list for registered applications and corresponding domain names, the URL itself may contain information to indicate the priority to use the custom application if available before invoking the default web browser.

1. A method for handling a click action on a uniform resource locator (URL) on a mobile device or a computer system, comprising:
retrieving an application from a URL-action table based on the clicked URL, the URL table comprising a list of one or more registered applications;
determining whether the application retrieved from the URL-action table is valid;
invoking the retrieved application if the application retrieved from the URL-action table is valid; and
invoking a default web browser if the application retrieved from the URL-action table is invalid.

2. The method of claim 1, wherein the list of one or more applications in the URL-action table is registered with corresponding domain names;

3. The method of claim 2, further comprising determining a domain name associated with the clicked URL, wherein the retrieved application is registered against the domain name associated with the URL.

4. The method of claim 1, wherein the URL-action table comprising a list of one or more registered applications may be stored in system memory or on a remote server accessible through network.

5. The method of claim 1, wherein each application in the list of one or more registered applications refers to a memory address on a computer system.

6. The method of claim 1, wherein the URL-action table comprising a list of one or more registered applications can be modified upon user request.

7. The method of claim 6, wherein one or more registered applications can be removed from the URL-action table upon user request.

8. The method of claim 6, wherein one or more applications can be registered and added to the URL-action table upon user request.

9. The method of claim 1, wherein the mobile device or computer system may be a mobile phone, tablet computer, laptop computer, notebook computer, or a computer device of any size that can run a web browser and non-web-browser application.

10. A computing device, comprising:
an input/output device configured to:
receive user inputs; and
display output information;
a memory for storing data used by the computing device; and
a processing unit for handling data processing, said processing unit comprising a uniform resource locator (URL) processing component configured to:
retrieve an application from a URL-action table upon receiving a user input of a click action on a URL, wherein the URL-action table comprises a list of one or more registered applications and corresponding domain names, and the application is retrieved based on the clicked URL;
determine whether the application retrieved from the URL-action table is valid;
invoke the retrieved application if the application retrieved from the URL-action table is valid; and
invoke a default web browser if the application retrieved from the URL-action table is invalid.

11. The computing device of claim 10, wherein the list of one or more applications in the URL-action table is registered with corresponding domain names;

12. The computing device of claim 11, wherein the URL processing component is further configured to determining a domain name associated with the clicked URL, wherein the retrieved application is registered with the domain name associated with the URL.

13. The computing device of claim 10, wherein the URL-action table may be stored in system memory or on a remote server accessible through network.

14. The computing device of claim 10, wherein each application in the list of one or more registered applications in the URL-action table refers to a memory address on a computer system.

15. The computing device of claim 10, wherein upon receiving a user request by the input/output device, said URL-action table comprising a list of one or more registered applications can be modified.

16. The computing device of claim 15, wherein a registered applications can be removed from said URL-action table upon a user request received by the input/output device.

17. The computing device of claim 15, wherein one or more applications can be registered and added to URL-action table upon a user request received by the input/output device.

18. The computing device of claim 1, wherein the computing device may be a mobile phone, tablet computer, laptop computer, notebook computer, or a computer device of any size that can run a web browser and non-web-browser application.

19. The computing device of claim 10, wherein the URL-action table is stored in the memory of the computing device.

20. The computing device of claim 10, wherein the URL-action table is stored in a remote server.
